(19) United States
(12) Patent Application Publication
(10) Pub. No.: US 2013/0160657 A1
(43) Pub. Date: Jun. 27, 2013

(54) Coffee/Espresso Machine with a Milk Froth Generating Device for the Preparation of Cappuccino

(71) Applicant: Eugster/Frismag AG, Amriswil (CH)

(72) Inventors: Gotthard Mahlich, Kronberg (DE); Markus Schob, Uzwil (CH)

(73) Assignee: Eugster/Frismag AG, Amriswil (CH)

(21) Appl. No.: 13/722,664

(22) Filed: Dec. 20, 2012

(30) Foreign Application Priority Data
Dec. 22, 2011 (DE) 202011109479.4

(51) Int. Cl. A47J 31/44

(52) U.S. Cl. CPC A47J 31/4485
USPC 99/300

(57) ABSTRACT

In a coffee/espresso machine with a milk froth generating device for preparing cappuccino, an outflow distributor which includes two outflow tubes being liquid-conductively connected to an espresso inflow. The outflow tubes are bent downwardly from the ends of a distributor tube of the outflow distributor. The milk froth generating device which comprises a Venturi tube, a mixing and frothing chamber and, following in flow direction, a nozzle arrangement according to the Laval principle having a nozzle throat is also liquid-conductively connected to the outflow distributor. The nozzle arrangement opens directly into a central connecting section of the distributor tube.

### BACKGROUND OF THE INVENTION

1. Field of the Invention

The present invention relates to a coffee/espresso machine with a milk froth generating device for preparing cappuccino.

2. Description of the Related Art

A prior art coffee/espresso machine of this genus is so designed that it can pass milk froth and espresso, also one after the other, into one cup, or two cups, as collecting vessel(s) placed on a plate while it is not necessary to move them, and can easily and thoroughly be cleaned (EP-A-2 301 396). To this end, the coffee/espresso machine includes an outflow distributor with two outflow tubes which starting from a distributor tube of the outflow distributor are angularly bent downwardly and are open at the lower end. The distributor tube of the outflow distributor is liquid-conductively connected with a central espresso inflow. Of two milk froth ducts connected separately from each other with at least one milk froth generating device, one of each opens into an upper end of one of the two outflow tubes. In order to enhance the distribution effect, the distributor tube is substantially horizontal and may extend, if required, from the central espresso inflow downwardly inclined about an acute angle to the upper ends of the outflow tubes. The coffee/espresso machine is advantageously operated in combination with a control of the espresso brewing unit and of the milk froth generating device so that, automatically, first milk froth and subsequently espresso for preparing cappuccino is generated flowing through the outflow tubes. Consequently, the milk froth residues remaining for the moment in the outflow tubes after the milk froth has flown out will extensively be washed out by the subsequent espresso passage, and in a following rinsing process with water, only the remaining espresso residues need be rinsed out of the outflow tubes.

Furthermore, an automated coffee machine for dispensing coffee, milk and/or milk froth has also been known which includes at least one coffee supply channel and a milk/milk froth supply channel with two spaced channel outlets the respective space relative to each other being determined by the alternative common filling of two drink containers or of only one single drink container (EP-A-2 186 454). In this automated coffee machine, there are provided two coffee supply channels in particular which are assigned to one of the two channel outlets each, and a channel fork with two sub-channels which communicatively connects the milk/milk froth supply channel with the two channel outlets. The sub-channels of the channel fork are open on top and include particularly in the interior lower axial edges on the side faces where they but against the approximately horizontal base of the sub-channels which are difficult to clean. With a view thereto, the channel fork with the sub-channels together with the coffee supply channels are preferably designed as one unit detachable from the automated coffee machine so that it can be demounted for cleaning by either hand or by a dish washer. The detachability of this unit, however, requires considerably increased engineering efforts.

DE 10 2010 038 112 A1 discloses a drink preparation machine, particularly for preparing coffee, espresso, milk shakes, having an outlet housing portion with which a removable outflow part is detachably connected which comprises a first outflow for coffee and a second outflow for milk and/or milk froth. A first chamber for the passage of coffee leads to the first outflow, and a second chamber for the passage of the milk and/or milk froth flow coming from a mixing chamber leads to the second outflow.

A further prior art espresso machine includes an outflow distributor only for brewed coffee and foam generated by it, not however for milk froth, having a cutting edge which distributes the coffee and the foam to two outflows (DE 40 37 366 A1). Although in this embodiment no milk froth can stick on, the outflow distributor is connected, preferably easily detachable for cleaning, with a coffee filter in which a nozzle insert is provided. The nozzle insert includes an upper cylindrical inflow section and a subsequent nozzle section below. An upper end section of the outflow distributor has an open ring slot with air supply grooves to the nozzle section. In the end section, a diffuser portion is formed out subsequent to the upper nozzle section, followed in downward direction by a cylindrical channel section and a second nozzle portion above the cutting edge of the outflow valve. In the cylindrical channel section, an axial turbine wheel is arranged. During the course of a coffee passage, an under pressure is generated at the ring slot and air is sucked in which is blended with the coffee. The axial turbine wheel driven by outflowing coffee adds to the generation of small air bubbles. This arrangement solely for coffee foam generation and distribution requires considerable engineering efforts.

### BRIEF SUMMARY OF THE INVENTION

The object of the present invention is to further improve in a constructionally simple way the (pre)cleaning of the outflow distributor with the two outflow tubes for coffee and milk froth together and, in particular, to render detachability of the outflow distributor for cleaning needless.

Accordingly, the coffee/espresso machine of the present invention is a coffee/espresso machine with a milk froth generating device for preparing cappuccino and with two outflow tubes liquid-conductively connected to an espresso inflow, wherein the espresso inflow is connected to an outflow of an espresso brewing unit; an outflow distributor includes the two outflow tubes and is liquid-conductively connected to the espresso inflow; from ends of a distributor tube of the outflow distributor, the outflow tubes are arranged downwardly bent and are open at the lower end; and the milk froth generating device comprising a Venturi tube, a mixing and frothing chamber and, following in flow direction, a nozzle arrangement according to the Laval principle having a nozzle throat is liquid-conductively connected to the outflow distributor; and in this coffee/espresso machine, the nozzle arrangement of the milk froth generating device opens directly into a central connecting section of the distributor tube.

The present invention is, as seen from the above, based on a coffee/espresso machine with a milk froth generating device comprising a Venturi tube provided in a flow channel between a steam supply duct and a mixing and frothing chamber and a nozzle arrangement subsequent thereto in flow direction operating according to the principle of a Laval tube. Such a nozzle arrangement includes a compression space in flow direction in front of a nozzle throat and following it, an expansion zone which may be formed by an expansion space of the nozzle arrangement.

Since such a nozzle arrangement of the milk froth generating device opens, according to the present invention, directly into a central connecting section of a distribution tube of an outflow distributor, no particular milk froth supply duct to the outflow distributor is required, which outflow distributor has already been provided for the outflow distribution of coffee/espresso. The production expenditure can be small. In operation of the machine, otherwise required cleaning of milk/milk froth conducting tubes can be dispensed with, as at least the outflow distributor consisting of the distributor tube and outflow tubes can effectively be rinsed by coffee/espresso which particularly for cappuccino preparation is passed into at least one receiving vessel, or cup, after milk froth introduction, and can further be cleaned by water, if necessary.

Moreover, an assembly of such an arrangement of the outflow distributor is particularly compact.

According to the present invention, the espresso inflow for the espresso to be distributed by the outflow distributor opens preferably into the nozzle throat of the nozzle arrangement, or downstream of the nozzle throat into an expansion space of the nozzle arrangement, that is, in both cases into an area of the nozzle arrangement wherein the espresso supplied is accelerated, for effective rinsing not only of the outflow distributor but also, at least partly, of the nozzle arrangement.

Instead, it is possible to pass the espresso inflow separately from the nozzle arrangement into the connecting section of the distributor tube so that rinsing by espresso cannot start before the connecting section.

A cost-effective and compact embodiment of the nozzle arrangement of the milk froth generating device arranged before the outflow distributor is obtained, according to the present invention, in that the nozzle throat of the nozzle arrangement is hollow-cylindrically elongated up to the connecting section of the distributor tube. In this case, nozzle-near sections of the distributor tube inclusive of the connecting section constitute expansion zones.

As the connecting section of the distributor tube, one should consider its tubular section which defines the lateral mouth of the nozzle arrangement.

In this embodiment of the nozzle throat according to the present invention, an espresso inflow opens laterally into it, which may simply be provided in the form of a bore. The elongated nozzle throat, too, is suitably realized as a bore.

In the embodiment of the above-mentioned expansion zones in the distributor tube, the clear cross sectional area of the distributor tube, at least at its connecting section, is larger than the one of the nozzle throat elongated to constitute the connecting section.

In a variant of the coffee/espresso machine according to the present invention, an expansion space of the nozzle arrangement linking up to the nozzle throat in flow direction and expanding in its cross sectional area extends up to and into the connecting section of the distributor tube. In this variant, the expansion space can be optimized practically independently from the shape of the distributor tube.

In connection with the last-mentioned variant, a coffee inflow duct may, according to the present invention, preferably extend up to and into the nozzle throat and may be designed in it as a slot nozzle. The slot of the slot nozzle which is tighter relative to the internal cross section of the espresso inflow duct is provided on the side of the espresso inflow duct which faces the expansion space of the nozzle arrangement, and extends at right angles relative to the flow direction of the milk/air mixture or the milk froth through the nozzle throat. With a view to the arrangement of the slot nozzle in the nozzle throat, the expansion space of the milk frothing device acts simultaneously as expansion zone of the slot nozzle, wherein the expansion zone may comprise still further sections near the nozzle inclusive of the connection sections of the distributor tube. An advantage of this arrangement consists in that the coffee brew passed through the slot nozzle is compressed in the slot nozzle and subsequently expanded, which leads to further improved crema generation.

In the following, three embodiments of a structural unit of a milk froth generating device for preparing cappuccino having an outflow distributor with two outflow tubes for a coffee/espresso machine will be described based on a drawing with three figures in which further advantageous features of the present invention may be disclosed.

BRIEF DESCRIPTION OF THE SEVERAL VIEWS OF THE DRAWINGS

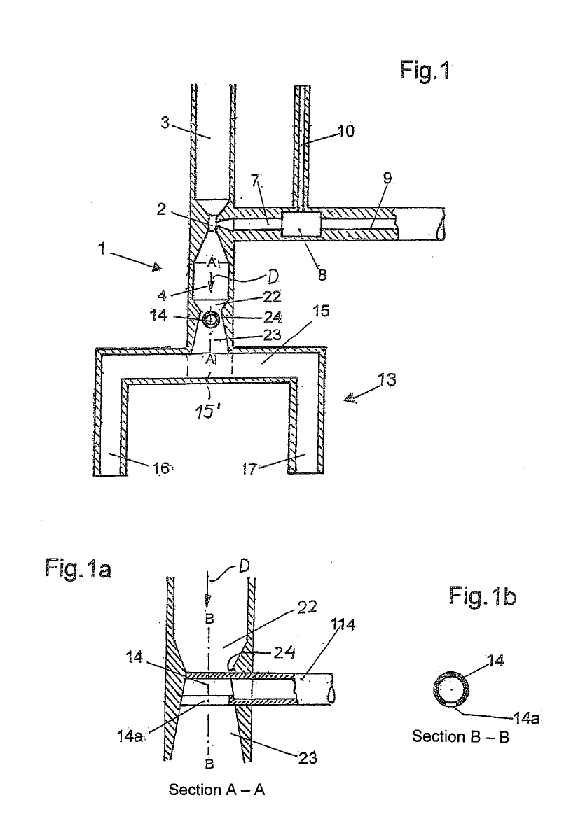

FIG. 1 shows a first embodiment of the present invention, illustrating a structural unit of a milk froth generating device opening directly into an outflow distributor, in a longitudinal section,

FIG. 1a shows a section of the milk froth generating device according to FIG. 1 in a sectional plane A-A in an enlarged representation as compared to FIG. 1,

FIG. 1b shows as a detail of the first embodiment from FIGS. 1 and 1a an espresso inflow formed as a slot nozzle in a cross section in the sectional plane B-B in FIG. 1a,

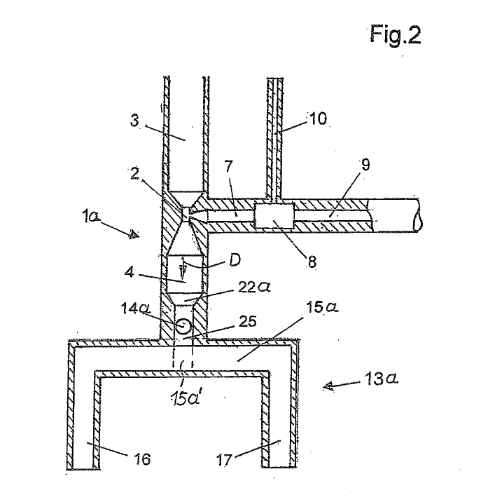

FIG. 2 shows a second embodiment of the present invention, illustrating a milk froth generation device opening directly into an outflow distributor, in a longitudinal section, and

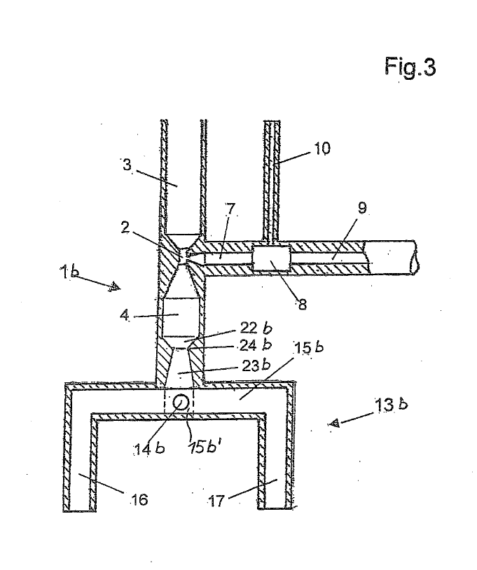

FIG. 3 shows a third embodiment of the present invention, illustrating a milk froth generation device opening directly into an outflow distributor, in a longitudinal section.

In the figures, identical parts are referred to by identical reference numerals.

### DETAILED DESCRIPTION OF THE INVENTION

In FIG. 1, number 1 refers to a milk froth generating device including a Venturi tube 2 which is arranged in a flow channel between a steam supply duct 3 and a mixing and frothing chamber 4. A milk/air mixture duct 7 connected with a milk/air pre-mixing chamber 8 leads to the Venturi tube 2. The milk/air pre-mixing chamber 8 is connected with a milk inflow duct 9, on one hand, and an air duct 10, on the other, which can be closed by an air valve, not shown, so that, if required, it will not supple any milk/air pre-mixture but rather solely milk to Venturi tube 2.

The basic function of the milk froth generating device consists in that by steam flowing into the steam supply duct 3, a milk/air mixture or, in case of a closed air duct 10, milk is suctioned in the Venturi tube 2 and processed in the frothing chamber to either become milk froth or heated milk.

The milk froth generating device 1 comprises, following in flow direction D to the mixing and frothing chamber, a nozzle arrangement 22 according to the Laval principle which includes, in flow direction D and subsequent to the mixing and frothing chamber, a compression space, not designated, in front of, and an expansion space 23, after a nozzle throat 24. The compression space and the expansion space 23 are realized, as shown in FIG. 1, by approximately conical nozzle sections between which the annular nozzle throat 24 is provided. Therefore, the expansion space 23 constitutes part of the milk froth generating device 1.

An outflow distributor 13 of the structural unit of this milk froth generating device 1 comprises an essentially central distributor tube 15 at the two ends whereof one outflow tube each, 16 or 17, is arranged in a vertically bent downward manner and is open at its lower end above a common surface, not shown, for placing cups and similar receiving vessels.

As can be seen from FIG. 1, the expansion space 23 of the nozzle arrangement 22 opens directly into the distributor tube 15 of the outflow distributor 13, namely in the tubular connecting section 15a thereof which directly includes the opening of the expansion space 23 into the distributor tube 15, as indicated in FIG. 1.

Sections of the distributor tube 15 near the throttle, particularly the connecting section 15a, may in this environment add to the expansion effect of the expansion space 23.

From FIGS. 1 and 1a, it can be taken that an espresso inflow duct 114 extends as espresso inflow duct 14 into the nozzle arrangement 22, namely at the beginning of the expansion space 23 in flow direction D subsequent to the nozzle throat 24. In a similar embodiment, the espresso inflow duct might also be guided into the nozzle throat with substantially the same effect. The espresso inflow duct 114 is provided, on the side facing the expansion space 23, with an elongated slot which forms a slot nozzle as espresso inflow 14a because the slot is tighter than the internal cross section of the espresso inflow duct 114. An expansion zone of the slot nozzle passes over into the expansion space 23 of the milk froth generating device. By the slot nozzle, the coffee brew in espresso inflow duct 114 is first compressed before it is expanded after exit from the slot nozzle, which leads to a particularly good crema.

Subsequently, the coffee liquid passes, as the milk froth did preferably before, from the expansion space 23 of the milk froth generating device 1 directly into the connecting section 15a of the connecting tube 15 of the outflow distributor 13 in which it is evenly distributed into the two outflow tubes 16, 17. From each of the two outflow tubes 16, 17, therefore, flows an even portion of milk froth and espresso either into one receiving vessel each or into a suitably placed common receiving vessel.

The milk froth generating device 1a of the second embodiment differs from the milk froth generating device 1 of the first embodiment in the design of the nozzle throat 25 of the nozzle arrangement 22a according to the Laval principle in FIG. 2. The elongated nozzle throat 25 is designed hollow-cylindrically and extends in flow direction D directly into the distributor tube 15a of the outflow distributor 13a, namely in its connecting section 15a′. In this second embodiment, sections of the distributor tube 15a near the nozzle, particularly its connecting section 15a′, act as expansion zone.

Into the elongated nozzle throat 25 of the nozzle arrangement 22a, there extends a simple espresso inflow 14a in the shape of a bore so that the out-flowing espresso is accelerated in the elongated nozzle throat 25 and in the subsequent expansion zone in the distributor tube 15a, particularly the connection section 15a′, and can in this way effectively rinse those sections of the nozzle throat 25 and of the outflow distributor 15 which follow in flow direction D the espresso inflow 14a.

The third embodiment of the milk froth generating device 1b and of the outflow distributor 13b in FIG. 3 corresponds to the first embodiment according to FIG. 1 with the exception of the arrangement of the espresso inflow 14b which in this case opens into the connecting section 15b′ of the distributor tube 15b. The expansion space 23b of the nozzle arrangement 22b according to the Laval principle, therefore, extends in this case, too, up to, and into, the connecting section 15b′ of the distributor tube 15.

In the third embodiment, therefore, the distributor tube 15b which also serves for passing milk froth may subsequently be rinsed together with the outflow tubes 16 and 17 by coffee/espresso.

1. A coffee/espresso machine with a milk froth generating device for preparing cappuccino and with two outflow tubes liquid-conductively connected to an espresso inflow, wherein
the espresso inflow is connected to an outflow of an espresso brewing unit,
an outflow distributor includes the two outflow tubes and is liquid-conductively connected to the espresso inflow,
from ends of a distributor tube of the outflow distributor, the outflow tubes are arranged downwardly bent and are open at the lower end, and
the milk froth generating device comprising a Venturi tube, a mixing and frothing chamber and, following in flow direction, a nozzle arrangement according to
the Laval principle having a nozzle throat is liquid-conductively connected to the outflow distributor; and wherein
the nozzle arrangement of the milk froth generating device opens directly into a central connecting section of the distributor tube.

2. The coffee/espresso machine according to claim 1, wherein
the espresso inflow either opens into the nozzle throat of the nozzle arrangement or downstream of the nozzle throat into an expansion zone of the nozzle arrangement.

3. The coffee/espresso machine according to claim 2, wherein
the nozzle throat of the nozzle arrangement is hollow-cylindrically elongated so that it extends up to and into the connecting section of the distributor tube.

4. The coffee/espresso machine according to claim 3, wherein
the clear cross sectional area of the distributor tube, at least at the connecting section, is larger than the one of the elongated nozzle throat.

5. The coffee/espresso machine according to one of claims 1 to 3, wherein
an expansion space in the nozzle arrangement following the nozzle throat in flow direction and expanding in its cross sectional area on the route of flow direction extends in the nozzle arrangement up to and into the connecting section of the distributor tube.

6. The coffee/espresso machine according to claim 5, wherein
an espresso inflow duct extending up to and into the nozzle throat is designed as a slot nozzle.

7. The coffee/espresso machine according to claim 2, wherein
the espresso inflow opens into the connecting section of the distributor duct.
